(19) United States
(12) Patent Application Publication
(10) Pub. No.: US 2011/0180737 A1
(43) Pub. Date: Jul. 28, 2011

(54) VALVE FOR CONTROLLING VOLUME FLOWS

(75) Inventors: Jochen Moench, Sinzheim (DE); Alois Hils, Sasbach (DE); Georg Reeb, Buehl Eisental (DE); Claudius Muschelknautz, Buehl (DE); Sven Urlaub, Lichtenau (DE)

(73) Assignee: ROBERT BOSCH GMBH, Stuttgart (DE)

(21) Appl. No.: 13/122,251

(22) PCT Filed: Oct. 5, 2009
(86) PCT No.: PCT/EP2009/062874

§ 371 Date: Apr. 1, 2011

(30) Foreign Application Priority Data
Oct. 20, 2008 (DE) 10 2008 042 947.3

(51) Int. Cl. F16K 31/54

(52) U.S. Cl. 251/248

(57) ABSTRACT

The invention proposes a valve (1) for controlling volume flows, in particular in a heating and/or cooling system of a motor vehicle, having a disk-shaped valve body (2) with at least one control opening (3) which, to control the volume flow, interacts with a disk-shaped sealing body (10) having at least one passage opening (11), wherein the disk-shaped valve body (2) has an external toothing (49) into which a pinion (42) engages in order to rotate the valve body (2). According to the invention, the pinion (42) and the external toothing (49) of the disk-shaped valve body (2) interact with one another by means of an evoloid toothing (43; 44). The valve according to the invention is provided for controlling volume flows, in particular in a heating and/or cooling system of a motor vehicle.

### BACKGROUND OF INVENTION

The present invention relates to a valve for controlling volume flows, in particular in a heating and/or cooling system of a motor vehicle, with a disk-shaped valve body having at least one control opening which, in order to control the volume flow, interacts with a disk-shaped sealing body having at least one passage opening, wherein the disk-shaped valve body has an external toothing in which a pinion engages in order to rotate the valve body.

DE 10 2006 053 311 A1 discloses a valve for controlling volume flows, in which an electric motor drives a worm/helical-gear transmission. The worm/helical gear rotates an output shaft of a disk-shaped valve body, which output shaft engages centrally on the valve body. There is therefore a central drive which engages in the center of the disk-shaped valve body. As an alternative to the worm/helical-gear transmission, it is proposed in paragraph 47 on page 6 of the German laid-open specification that the valve could also be a disk having an external toothing such that a pinion or a worm could engage there.

### SUMMARY OF THE INVENTION

By contrast, the valve according to the invention for controlling volume flows has the advantage of a simplified construction, which is associated with simplified installation, and of an increased torque at the valve body, which can be obtained by a higher transmission ratio. Furthermore, there is greater setting accuracy for rotating the valve body and improved transmission efficiency.

High transmission ratios can advantageously be achieved in a single transmission stage by means of the evoloid toothing according to the invention. In particular, there is very direct force transmission to the disk-shaped valve body and good transmission efficiency in comparison to a helical-gear transmission. In addition, the setting accuracy increases, as a transmission backlash over a larger diameter results in a smaller angular backlash at the evoloid toothing. It is also of advantage that overall only relatively small toothing forces are necessary, since the application of force takes place over a large diameter. An increase in the torque occurs by realization of a higher transmission ratio with the setting accuracy being increased at the same time. The evoloid toothing makes it possible not to require an angular offset between the disk-shaped valve body and a motor axis of an electromotive drive.

A simple construction of the valve with high setting accuracy is produced if the external toothing of the disk-shaped valve body is designed as a toothed quadrant. It has proven advantageous if the external toothing on the valve body covers a region of approximately 100 to 140 degrees in the circumferential direction.

Simple production is provided if the external toothing is provided on valve bodies by insert molding.

A simple construction and good sealing action are provided if the disk-shaped sealing body bears in a sealing manner against the disk-shaped valve body via at least one peripheral ring.

The toothing is well protected if the valve has a housing sleeve, against the inner wall side of which a sealing ring bears, said sealing ring bearing against a side of the disk-shaped valve body, which side faces away from the sealing body, via a sealing lip.

A simple construction and good sealing action are provided if the sealing body has at least one static molded seal on a side facing an actuating drive of the valve. It has proven advantageous to design the at least one molded seal as an elastomer seal.

The valve operates reliably if the sealing body is pressed onto the valve body via the at least one static molded seal and the sealing ring.

### BRIEF DESCRIPTION OF THE DRAWINGS

An exemplary embodiment of the invention is explained in more detail in the description below and further clarified with reference to the drawing, in which:

FIG. 1 shows a valve according to the invention in a perspective view in a direction looking at the disk-shaped valve body of said valve,

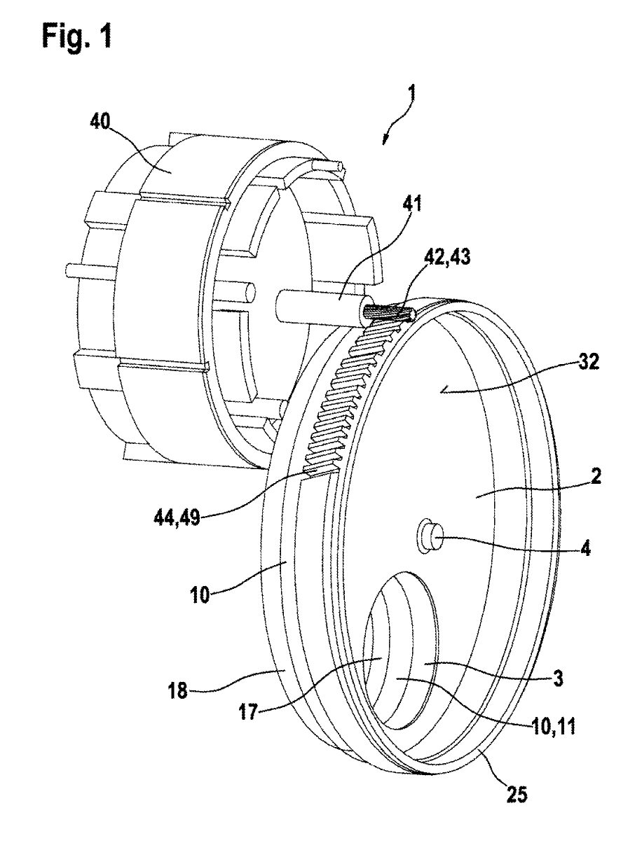

FIG. 2 shows the valve in a perspective view in a direction looking at the disk-shaped sealing body of said valve,

FIG. 3 shows a side view of the valve looking at the disk-shaped sealing body,

FIG. 4 shows a section through the valve according to IV-IV shown in FIG. 3, and

FIG. 5 shows an enlarged cutout from FIG. 4.

### DETAILED DESCRIPTION

The valve 1 according to the invention is provided in order to control volume flows which occur in particular in a heating and/or cooling system of a motor vehicle. Such regulating valves for an engine cooling system are also known under the term CCV (coolant control valve). They regulate the coolant temperature in coolant circuits of internal combustion engines between a radiator branch and a bypass branch. Thermo management is possible, in which the power of the cooling system can be matched to the operating state of the internal combustion engine to meet requirements. For example, the flow of cooling water can be reduced in the warming-up phase of the internal combustion engine. The rapid heating causes the viscosity of the engine oil to drop more rapidly, as a result of which the consumption can be reduced particularly when idling and in part-load operation while the air-conditioning regulation of the interior is simultaneously optimized. A hitherto customary thermostat can be replaced by the regulating valve in the cooling circuit.

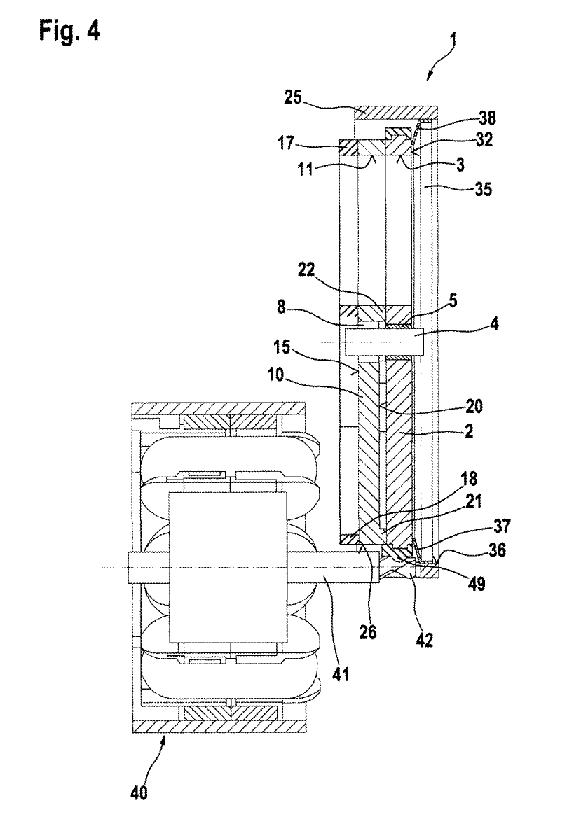

The valve 1, which may also be referred to as a rotary disk valve, has a disk-shaped valve body 2 having at least one control opening 3. The rotatably configured valve body 2 is centrally penetrated for this purpose by a shaft 4, by means of which said valve body is mounted in a floating and rotatable manner about the shaft 4, for example via a sleeve 5 illustrated in FIG. 4. A fixed, disk-shaped sealing body 10 designed to be somewhat smaller in diameter than the valve body 2 bears against the rotatably configured valve body 2 and surrounds the shaft 4 centrally at a small radial distance, for example by means of a through opening 8 of larger diameter.

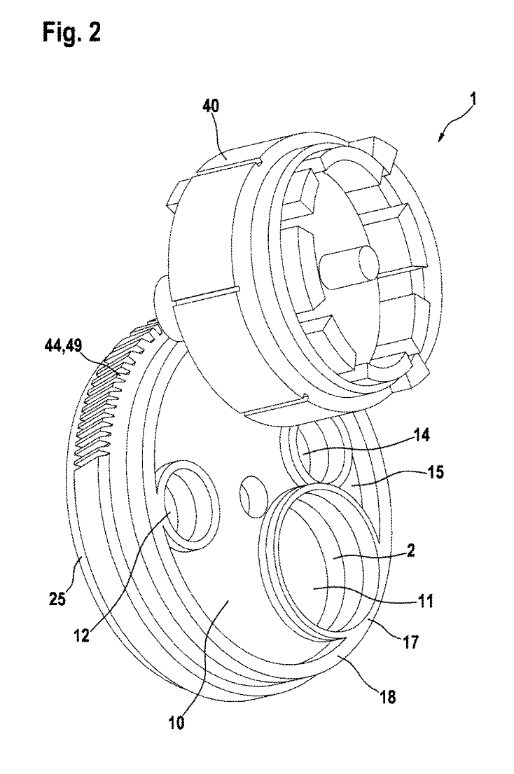

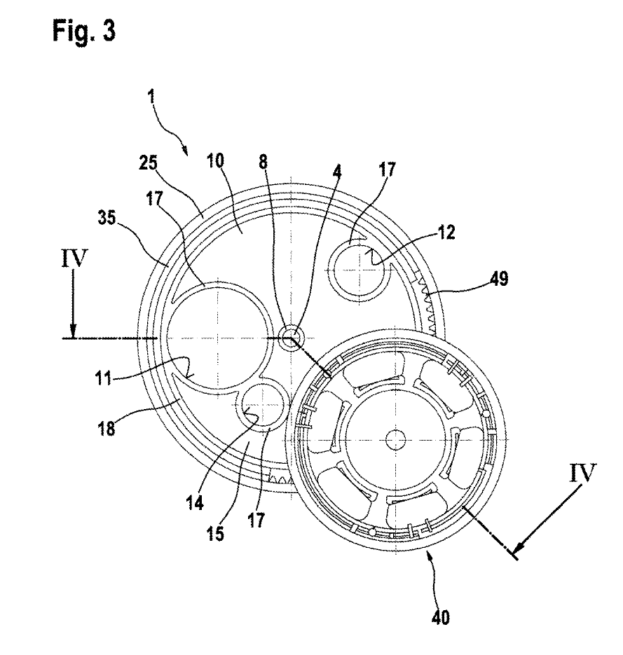

The sealing body 10 is immovable and is part of a housing of the valve 1. The sealing body 10 has, for example, a plurality of through openings which are illustrated in more detail in FIGS. 2 and 3. In the exemplary embodiment, a first, large through opening 11, a second, medium through opening 12, and a third, smaller through opening 14 are provided. The through openings 11, 12, 14 are bordered by static molded seals 17 on a side 15 of the sealing body 10, which side faces away from the valve body 2. In addition, a side border bounding the side 15 can also be surrounded or bordered by a molded seal 18. The molded seals 17, 18 are used for sealing purposes, for example upon connection of connections (not illustrated specifically) to the through openings 11, 12, 14 or of a further housing part of the valve 1, into which a medium, in particular coolant or cooling water, can flow as soon as the path from the control opening 3 of the valve body 2 has been correspondingly cleared. Depending on the position of the control opening 3 with respect to the respective through opening 11; 12 or 14, the actual throughflow area can thus be correspondingly changed or the volume flow can be controlled by rotation of the valve body 2. The disk-shaped valve body 2 may therefore also be referred to as a regulating disk. The molded seals 17; 18 can be designed as an elastomer seal.

The medium passes, for example via a connecting housing part (not illustrated specifically) which is connected on the right of a housing sleeve 25 in FIG. 3, to the control opening 3 and from there, depending on the rotational position of the disk-shaped valve body 2, on into one of the through openings 11; 12; 14. The function of the valve 1 is to block off and regulate flows of cooling water, this being achieved by a rotating movement of the valve body 2 in relation to a fixed sealing body 10. This enables various cross sections to be increased or reduced in a specific manner. FIG. 2 shows a fully open position of the control opening 3 and of the first, large through opening 11 of the sealing body 10.

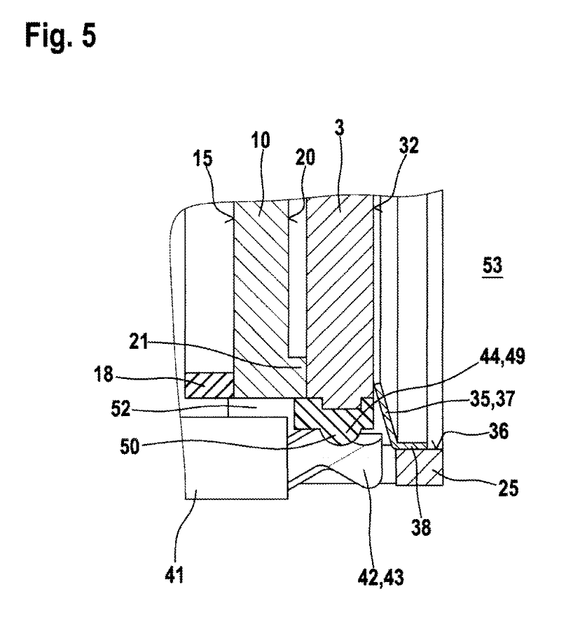

The valve body 2 may bear against the disk-shaped sealing body 10 in a planar manner. However, the valve body 2 may also not bear thereagainst in a planar manner, as shown in more detail in FIGS. 4 and 5, and may be at an axial distance from the sealing body 10. For this purpose, a peripheral elevation in the form of a border ring 21 is provided on a side 20 of the sealing body 10, which side faces the valve body 2. The border ring 21 extends in the radial direction from an outer surface 26 of the sealing body 10 somewhat radially inward and fully in the circumferential direction. The ring width of the border ring 21 therefore inwardly surrounds the sealing body 10 on the border side. In addition, a further ring 22 can in each case be provided in the same manner about each through opening 11; 12; 14, said ring surrounding or bordering the through opening 11; 12; 14 on the circumferential side. The two bodies 2, 10 are therefore in contact only via the border rings 21, 22. The disk-shaped sealing body 10 may also be referred to as a sealing disk.

To drive the valve body 2, the valve 1 has an electromotive actuating drive 40 which drives a pinion 42, for example via a drive shaft 41. The electromotive actuating drive 40 may be a stepping motor or the like. The pinion 42 in turn engages with the teeth thereof in an external toothing 49 of the valve body 2. According to the invention, the pinion 42 and the external toothing 49 of the disk-shaped valve body 2 interact with each other via an evoloid toothing 43, 44. Both the pinion 42 and the external toothing 49 are designed as an evoloid toothing 43 and 44, respectively, and form a transmission. The evoloid toothing 43, 44 is a special version of the involute toothing and provides a continuous meshing toothing, in particular even if the pinion 42 is only to have a few teeth. In the exemplary embodiment, the pinion 42 has, for example, three teeth. Fewer teeth are also possible, for example just a single tooth. It is therefore possible to achieve large transmission ratios in a single transmission stage. In particular, there is very direct force transmission to the disk-shaped valve body 2, and good transmission efficiency. In addition, the setting accuracy increases, since a transmission backlash over a larger diameter results in a smaller angular backlash at the evoloid toothing 43, 44.

It is also of advantage that overall only relatively small toothing forces are required, since the application of force takes place over a relatively large diameter. It is advantageously sufficient if the external toothing 49 of the disk-shaped valve body 2 is designed as a toothed quadrant and covers only part of the circumference of the valve body 2. In this case, the toothed quadrant or the external toothing 49 of the disk-shaped valve body 2 can cover approximately 100 to 140 degrees in the circumferential direction. The external toothing 49 can be provided on valve bodies 2 in a simple manner by insert molding. In principle, a transmission is also conceivable in which the required overlap ratio can be achieved by a plurality of offset, spur-toothed gearwheels.

As FIG. 4 shows, the housing sleeve 25 surrounds the valve body 2 and also the sealing body 10 both radially and axially. Only the external toothing 49 on the valve body 2 remains, for example, free. On the right of the valve body 2 or on a side 32 of the valve body 2, which side faces away from the actuating drive 40 of the valve body 2, a peripheral sealing ring 35 is provided, said sealing ring being supported on one side by a sealing lip 37 on the side 32 of the valve body 2 and bearing on the other side with a sleeve-shaped part 38 against an inner surface 36 of the housing sleeve 25. The sleeve-shaped part 38 and the sealing lip 37 of the sealing ring 35 form the shape of an L in section. In order to encapsulate a toothing space 50 of the pinion 42 and external toothing 49, a driving space 52 can be separated from a remaining interior space 53 of the valve 1 by means of the sealing ring 35 or the sealing lip 37 thereof and the border ring 21 of the sealing body 10. Said sealing point does not require 100 percent tightness. The task is rather to avoid relatively large foreign bodies, such as, for example, molding sand, from penetrating the toothing space 50. The sealing body 10 can be pressed onto the valve body 2, for example via the sealing ring 35 and the molded seals 17, 18, in order thereby to achieve a good sealing action. The sealing ring 35 together with the sealing lip 37 thereof serves to encapsulate the toothing space.

The valve according to the invention is provided for controlling volume flows, in particular in a heating and/or cooling system of a motor vehicle.

1. A valve for controlling volume flows, the valve comprising: a disk-shaped valve body having at least one control opening which, in order to control the volume flow, interacts with a disk-shaped sealing body having at least one passage opening, wherein the disk-shaped valve body has an external toothing which a pinion engages in order to rotate the valve body, characterized in that the pinion (42) and the external toothing (49) of the disk-shaped valve body (2) interact with each other via an evoloid toothing (43; 44).

2. The valve as claimed in claim 1, characterized in that the external toothing (49) of the disk-shaped valve body (2) is designed as a toothed quadrant.

3. The valve as claimed in claim 2, characterized in that the external toothing (49) on the valve body (2) covers a region of approximately 100 to 140 degrees in a circumferential direction.

4. The valve as claimed in claim 2, characterized in that the external toothing (49) is provided on the valve body (2) by insert molding.

5. The valve as claimed in claim 1, characterized in that the disk-shaped sealing body (10) bears in a sealing manner against the disk-shaped valve body (2) via at least one peripheral ring (21; 22).

6. The valve as claimed in claim 1, characterized in that the valve (1) has a housing sleeve (25), against the inner wall side of which a sealing ring (35) bears, said sealing ring bearing against a side (32) of the disk-shaped valve body (2), which side faces away from the sealing body (10), via a sealing lip (37).

7. The valve as claimed in claim 1, characterized in that the sealing body (10) has at least one static molded seal (17, 18) on a side (15) facing an actuating drive (40) of the valve (1).

8. The valve as claimed in claim 7, characterized in that the at least one molded seal (17; 18) is designed as an elastomer seal.

9. The valve as claimed in claim 7, characterized in that the sealing body (10) is pressed onto the valve body (2) via the at least one static molded seal (17; 18) and a sealing ring (35).

10. The valve as claimed in claim 1, characterized in that the valve is used in at least one of a heating system and a cooling system of a motor vehicle

11. The valve as claimed in claim 3, characterized in that the external toothing (49) is provided on the valve body (2) by insert molding.

12. The valve as claimed in claim 1, characterized in that the valve (1) has a housing sleeve (25), against the inner wall side of which a sealing ring (35) bears, said sealing ring bearing against a side (32) of the disk-shaped valve body (2), which side faces away from the sealing body (10), via a sealing lip (37), and further in that the sealing body (10) has at least one static molded seal (17, 18) on a side (15) facing an actuating drive (40) of the valve (1), the sealing body (10) being pressed onto the valve body (2) via the at least one static molded seal (17; 18) and the sealing ring (35).
